(19) United States
(12) Patent Application Publication
(10) Pub. No.: US 2007/0176557 A1
(43) Pub. Date: Aug. 2, 2007

(54) Plasma display panel and method manufacturing the same

(75) Inventors: Bo Hyun Kim, Suwon-si (KR); Min Soo Park, Seoul (KR); Deok Hai Park, Daegu (KR); Byung Gil Ryu, Seoul (KR); Young Sung Kim, Yongin-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/649,856

(22) Filed: Jan. 5, 2007

(30) Foreign Application Priority Data
Jan. 6, 2006 (KR) 10-2006-0001880

(51) Int. Cl. H01J 17/49

(52) U.S. Cl. 313/586

(57) ABSTRACT

A plasma display panel having improved luminous efficiency is disclosed. The plasma display panel according to an embodiment includes a first panel and a second panel. At least one pair of tips are formed at a dielectric layer disposed on the first panel at a surface thereof contacting a discharge space.

### CROSS-REFERENCE TO RELATED APPLICATION

This application claims the priority benefit of Korean Patent Application No. 10-2006-0001880, filed on Jan. 6, 2006, which is hereby incorporated by reference in its entirety as if fully set forth herein.

### BACKGROUND OF THE INVENTION

1. Field of the Invention

The present invention relates to a plasma display panel, and more particularly, to improvement of the luminous efficiency of a plasma display panel.

2. Discussion of the Related Art

Generally, a plasma display panel comprises an upper panel, a lower panel, and barrier ribs formed between the upper and lower panels to define respective discharge cells. The respective discharge cells are filled with a major discharge gas such as neon, helium, or a mixed gas of neon and helium, and with an inert gas containing a small amount of xenon (Xe). When a high-frequency voltage is applied to the plasma display panel such that discharge occurs in the respective discharge cells, vacuum ultraviolet rays are generated from the inert gas to cause phosphors present between the barrier ribs to emit light, and as a result, images are created. The plasma display panel with the above-stated structure has attracted more and more attention as the next-generation display device due to the small thickness and light weight thereof.

FIG. 1 is a perspective view schematically illustrating the structure of a plasma display panel according to a related art. As shown in FIG. 1, the plasma display panel comprises an upper panel 100 and a lower panel 110 integrally joined in parallel to and at a certain distance apart from the upper panel 100. The upper panel 100 includes an upper substrate 101 as a display plane on which images are displayed and a plurality of sustain electrode pairs, each pair consisting of a scan electrode 102 and a sustain electrode 103, arranged on the upper substrate 101. The lower panel 110 includes a lower substrate 111 and a plurality of address electrodes 113 arranged on the lower substrate 111 such that the plurality of address electrodes 113 are disposed generally perpendicular to the plurality of sustain electrode pairs.

Stripe type (or well type, etc.) barrier ribs 112 for forming a plurality of discharge spaces, i.e., discharge cells, are arranged in parallel with each other on the lower panel 110. The plurality of address electrodes 113, which generate vacuum ultraviolet rays due to address discharge, are arranged in parallel with the barrier ribs 112. Red (R), green (G), and blue (B) phosphors 114 are applied to the upper side of the lower panel 110 to emit visible rays at the time of address discharge, and, as a result, images are displayed. A lower dielectric layer 115 is formed between the address electrodes 113 and the phosphors 114 to protect the address electrodes 113.

An upper dielectric layer 104 is formed on the sustain electrode pairs 103, and a protective layer 105 is formed on the upper dielectric layer 104. The top surface of the upper dielectric layer 104 and the top surface of the protective layer 105 are flat or planar. The upper dielectric layer 104, which is included in the upper panel 100, however, is worn out due to the bombardment of positive (+) ions at the time of discharge of the plasma display panel. At this time, short circuits of the electrodes may be caused by metal elements such as sodium (Na). For this reason, a magnesium oxide (MgO) thin film as the protective layer 105 may be formed by coating to protect the upper dielectric layer 104.

However, the plasma display panel as described above according to the related art has the following problems and limitations.

Firstly, even if the protective layer including magnesium oxide of the plasma display panel can sufficiently withstand the bombardment of positive (+) ions, the protective layer does not and cannot effectively lower the discharge voltage, which in turn increases the power consumption of the plasma display panel. This limitation is caused by the physical characteristics of magnesium oxide, which is a principal material for the protective layer. Specifically, this is because the magnesium oxide has a low secondary electron emission coefficient with respect to ions incident on the protective layer at the time of plasma discharge.

### SUMMARY OF THE INVENTION

Accordingly, the present invention is directed to a plasma display panel that substantially obviates or addresses one or more problems due to limitations and disadvantages of the related art.

An object of the present invention is to provide a plasma display panel having improved secondary electron emission characteristics.

Another object of the present invention is to provide a plasma display panel having low firing voltage and low power consumption due to the improvement of the secondary electron emission characteristics.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel according to an embodiment includes a first panel and a second panel coupled to the first panel with a distance therebetween, wherein the first panel includes at least one pair of tips formed at a dielectric layer disposed on the first panel at a surface thereof contacting a discharge space.

In another aspect of the present invention, a method of manufacturing a plasma display panel includes forming a dielectric layer on a sustain electrode pair of a first panel, forming at least one pair of tips on the dielectric layer, and forming a protective layer on the dielectric layer having the at least one pair of tips formed thereon.

According to one aspect, the present invention provides an upper panel structure for a plasma display panel, comprising: a substrate; a plurality of sustain electrode pairs formed on the substrate; and a dielectric layer over the plurality of sustain electrode pairs, the dielectric layer including at least one projection corresponding to at least one of the plurality of sustain electrode pairs.

According to another aspect, the present invention provides a plasma display panel device comprising: a first panel including a plurality of address electrodes; a second panel including a pair of sustain electrodes, and a dielectric layer having at least one projection corresponding to the pair of sustain electrodes; and barrier ribs disposed between the first and second panels.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a plasma display panel according to a related art;

FIG. 2 is a view illustrating an upper panel of a plasma display panel according to an embodiment of the present invention;

FIG. 3 is a view illustrating an example of a plasma display panel having line type tips according to an embodiment of the present invention;

FIG. 4 is a view illustrating an example of a plasma display panel having dot type tips according to an embodiment of the present invention; and

FIG. 5 is a view illustrating the structure of a discharge cell of a plasma display panel according to an embodiment of the present invention.

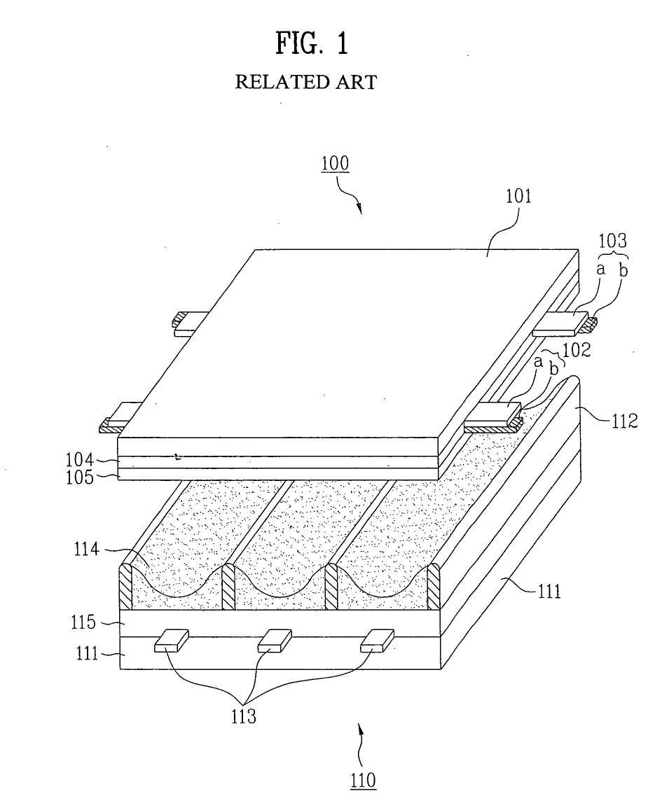

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

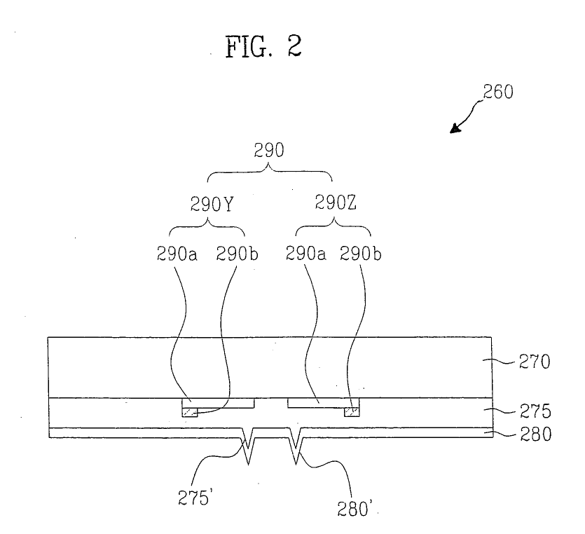

First, a plasma display panel according to an embodiment of the present invention will be described in detail with reference to FIG. 2, which is a view illustrating an upper panel of a plasma display panel according to an embodiment of the present invention.

Referring to FIG. 2, the upper panel 260 of the plasma display panel according to this embodiment is constructed to have a structure in which a sustain electrode pair 290, an upper dielectric layer 275, and a protective layer 280 are sequentially formed on an upper substrate 270. Although only one sustain electrode pair 290 is shown, a plurality of such sustain electrode pairs can be or are provided in the plasma display panel.

One or more tips 275′ are formed at a part of the upper dielectric layer 275. The tips 275′ may be made of the same material as the upper dielectric layer 275. That is, the tips 275′ can be formed as integral part of the upper dielectric layer 275. The protective layer 280 is formed on the upper dielectric layer 275 and the tips 275′, with a uniform (or substantially uniform) thickness, and therefore, one or more tips 280′ are also formed at the protective layer 280. However, as a variation, the tips 280′ may not have a uniform thickness over the tips 275′ but still maintain the shape of the tip.

Preferably, a pair of tips 275′ are formed in at least one or in each discharge cell such that the tips 275′ are opposite to each other about a discharge gap defined between the respective tips 275′. Here, the discharge cell preferably means a space defined by barrier ribs, and the discharge cell can have different shapes depending upon the types (e.g., stripe type, well type, or delta type) of the barrier ribs. The discharge gap preferably means a space where the discharge actually occurs. Specifically, the discharge gap preferably means a space defined between a pair of sustain electrodes 290y and 290z. Also, each of the sustain electrodes 290y and 290z is formed by sequentially stacking a transparent electrode 290a and a bus electrode 290b.

In this embodiment, the tips 275′ are formed, in a pair, at the respective sustain electrode pair disposed in the respective discharge cell. Also, preferably, the tips 275′ are disposed at positions corresponding to the inner ends of the opposite transparent electrodes 290a. For instance, portions of the tips 275′ can be aligned with the inner ends of the transparent electrodes 290a. As an example only, the inner ends of the tips 275′ can be aligned with the inner ends of the transparent electrodes 290a.

Since the protective layer 280 is formed on the upper dielectric layer 275 and the tips 275′ preferably with an approximately uniform thickness, the tips 280′ formed at the protective layer 280 are disposed at the same (or substantially the same) positions as the tips 275′ formed on the upper dielectric layer 275 while the tips 280′ have the same (or substantially the same) shape as the tips 275′. In this embodiment, the pair of tips 275′ disposed in a discharge cell are preferably spaced apart from each other by approximately 50 μm to 100 μm. However, the distance between the tips 275′ may be changed depending upon the size of the discharge cell.

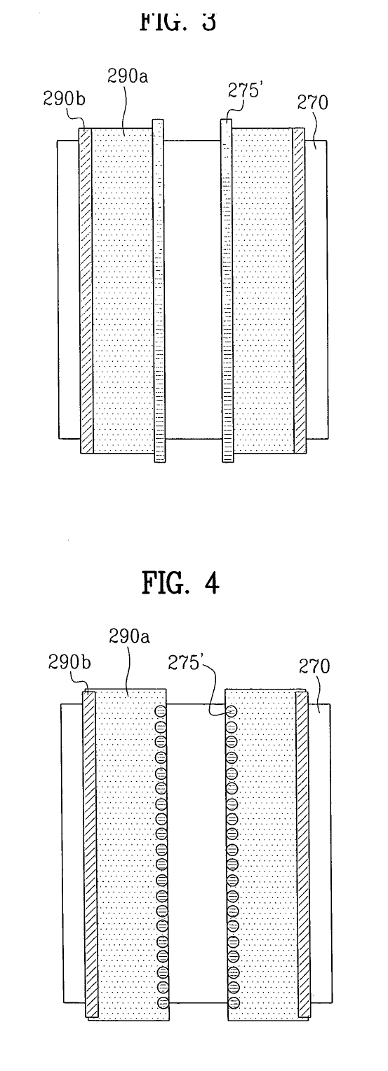

As mentioned above, FIG. 2 is a sectional view illustrating, only as an example, one discharge cell, in which a pair of tips are disposed. Here, the pair of tips may be formed in a line type structure or in a dot type structure, which will be discussed in more detail referring to FIGS. 3 and 4.

FIG. 3 is a view illustrating a plasma display panel having line type tips according to an embodiment of the present invention. For easy understanding, the tips are shown, but the upper dielectric layer (except the tips) and the protective layer are omitted from the drawing.

As shown in FIG. 3, a pair of transparent electrodes 290a and a pair of bus electrodes 290b are spaced a predetermined distance from each other on an upper substrate 270 in an upper panel of a plasma display panel. The bus electrodes 290b are formed at the outside ends of the opposite transparent electrodes 290a. At the inside ends of the transparent electrodes 290a, there are formed a pair of tips 275′. In this embodiment, the tips 275′ are formed in a line type structure along the transparent electrodes 290a. For instance, each of the tips 275′ can be a ridge extending in the same direction as the bus electrode 290b.

As an example, each of the line type tips 275′ preferably has a width of 10 μm to 40 μm. Here, the width of the line type tips 275′ indicates the lateral length of the line type tips 275′ in FIG. 3. Also, as an example, each of the line type tips 275′ preferably has a height of 10 μm to 40 μm. Here, the height of the line type tips 275′ indicates the height of the tips 275′ protruding from the top surface of the upper dielectric layer (280). Other dimensions for the line type tips 275′ may be possible as long as the height of the tips is not too small or too large. If the height of the tips is too small, the electric field concentration effect, which will be described below, may be reduced. If the height of the tips is too large, on the other hand, the difficulty in manufacturing the tips and the manufacturing costs of the tips may increase, and the discharge space may be structurally deformed. Also, the line type tips can be preferably spaced apart from each other by 50 μm to 100 μm.

FIG. 4 is a view illustrating a plasma display panel having dot type tips according to an embodiment of the present invention. For easy understanding, the tips are shown, but the upper dielectric layer (except the tips) and the protective layer are omitted from the drawing.

As shown in FIG. 4, a pair of transparent electrodes 290a and a pair of bus electrodes 290b are spaced a predetermined distance from each other on an upper substrate 270 in an upper panel of a plasma display panel. The bus electrodes 290b are formed at the outside ends of the opposite transparent electrodes 290a. At the inside ends of the transparent electrodes 290a, there are formed a pair of tips 275′. In this embodiment, the tips 275′ are formed in a dot type structure, e.g., over and along the transparent electrodes 290a. Here, the formation of the tips in the dot type structure preferably means that each tip 275′ includes a plurality of dots, and the dots are arranged in line. For instance, these dots would be disposed above the bus electrodes 290b, and would be aligned with the inner ends of the bus electrodes 290b.

As an example, the dots of the respective tips 275′ preferably have a size of 10 μm to 40 μm and a height of 10 μm to 40 μm. Here, the ‘size’ of the dots of the respective tips preferably means the diameter of the dots for circular dots and the length of a side of each dot for square dots. The meaning of the ‘height’ has been described above in connection with FIG. 3, and the reason(s) to limit the size of the tips has also been described above in connection with FIG. 3. Other dimensions for the dot type tips 275′ may be possible as long as the they are not too small or too large. Also, the dot type tips can be preferably spaced apart from each other by 50 μm to 100 μm.

The tips 275′ (e.g., the line type or dot type) are preferably spaced apart from each other by a uniform distance as described above. Alternatively, the respective tips may be concentrated in a discharge cell region, especially, between the discharge gaps so as to increase the electric field concentration effect, which will be described below. Here, the term ‘concentrated’ preferably means that the respective tips are spaced apart from each other by a small distance. In another example, the tips 275′ may not be formed in a non-discharge region.

Preferably, the tips 275′ as shown in FIGS. 2-4 have pointy ends/tops. However, the top ends of the tips 275′ may be round or flat as long as the general shape of the tips 275′ is maintained. For instance, the cross-section of the tips 275′, along a direction perpendicular to the lateral direction in which the tips 275′ extend as shown in FIGS. 3 and 4, can be in the shape of generally a triangle, a trapezoid, a semi-circle or an extended semi-circle. Also as a variation, each tip 275′ can be referred to as a projection in which the top end of the projection can be pointy, round or flat. Still as a variation, each tip 275′ may have more than one projection, e.g., the cross-section of the tip may be in the shape of “M” or the like.

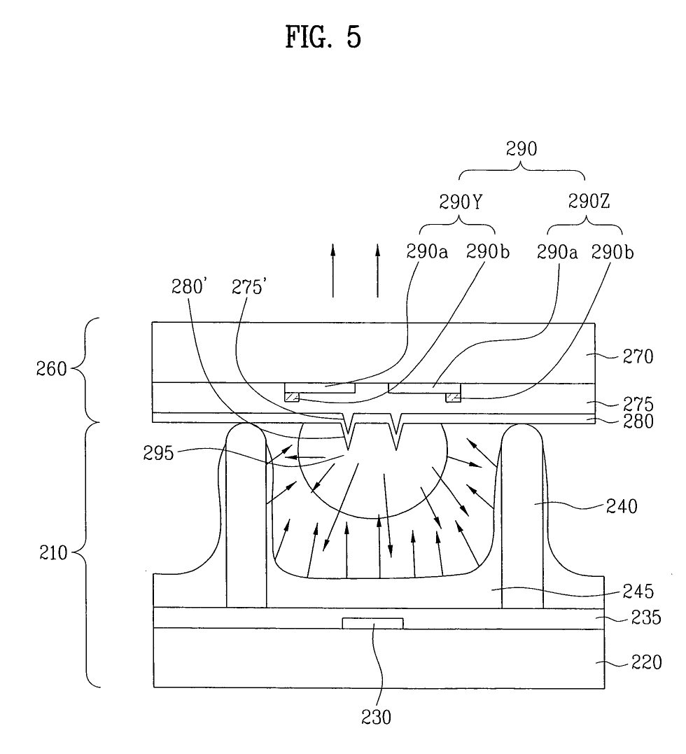

FIG. 5 is a view illustrating the structure of a discharge cell of a plasma display panel according to an embodiment of the present invention.

Referring to FIG. 5, a three-electrode alternating current surface discharge type plasma display panel is constructed to have a structure in which an upper panel 260 and a lower panel 210 are joined with each other while barrier ribs 240 are disposed between the upper panel 260 and the lower panel 210. The lower panel 210 is constructed to have a structure in which an address electrode 230 and a lower dielectric layer 235 are sequentially formed on a lower substrate 220. Although one electrode 230 appears to be shown, the lower panel 210 includes a plurality of such electrodes 230 between the respective barrier ribs 240. The barrier ribs 240 are formed on the lower dielectric layer 235. Neighboring discharge cells are separated from each other by the barrier ribs 240. A phosphor 245 is applied to the side surfaces of the barrier ribs 240 and the lower dielectric layer 235. The barrier ribs 240 can have any known shape or structure.

The upper panel 260 is constructed to have a structure in which a sustain electrode pair 290 is formed on an upper substrate 270 such that the sustain electrode pair 290 intersects the address electrode 230. Although one sustain electrode pair 290 appears to be shown, a plurality of such sustain electrode pairs 290 are provided in the upper panel 260. Preferably, the upper panel 260 in FIG. 5 is the same as the upper panel 260 of FIG. 2. Transparent electrodes 290a have low conductivity. For this reason, bus electrodes 290b are further provided to reduce the resistance of the sustain electrode pair 290Y and 290Z. On the upper substrate 270 and the sustain electrode pair 290 are formed an upper dielectric layer 275 and tips 275′, which are disposed in a pair in each discharge cell. On the upper dielectric layer 275 and the tips 275′ are formed a protective layer 280. The protective layer 280 is preferably formed with a uniform thickness, and therefore, tips 280′ are also formed at the protective layer 280. The tips 275′, the upper dielectric layer 275, the tips 280′ and the protective layer 280 are preferably the same as those discussed above in connection with FIGS. 2-4.

The lower panel 210 and the upper panel 260 of the plasma display panel are joined to each other, while being opposite to each other, so as to define discharge cells. Between the sustain electrode pairs 290 or at the top of the barrier ribs 240 are disposed a black matrix or a black top for absorbing external light introduced into the discharge cells such that the external light is not reflected. Each discharge cell defined by the upper panel 260, the lower panel 210, and the barrier ribs 240 is filled with a discharge gas. The discharge gas is an inert gas, for example, a mixed gas of helium and xenon (He+Xe) , a mixed gas of neon and xenon (Ne+Xe), or a mixed gas of helium, neon, and xenon (He+Ne+Xe).

In the plasma display panel with the above-stated construction according to the present invention, an electric field is concentrated on the tips 275′ and 280′ formed respectively on the upper dielectric layer 275 and the protective layer 280 at the time of discharge. As a result, the emission of secondary electrons is accelerated, and therefore, the firing voltage is lowered. Accordingly, the present invention reduces the power consumption of the plasma display panel and enhances the operation of the plasma display panel.

Hereinafter, a method of manufacturing the plasma display panel with the above-stated construction according to an embodiment of the present invention will be described.

First, one or more sustain electrode pairs and an upper dielectric layer are sequentially formed on an upper substrate. The upper dielectric layer is formed using a conventional method such as a screen printing method, a green sheet lamination method, a coating method, and a dispensing method. Then, one or more pairs of tips are formed on the upper dielectric layer. The pair(s) of tips can be constructed in a line type structure or in a dot type structure as discussed above. The shapes of the tips and the distance between the tips have been described above.

When the tips are formed in the line type structure, for example, the tips may be formed with the conditions that each tip line has a width of about 10 μm to 40 μm and a height of about 10 μm to 40 μm. When the tips are formed in the dot type structure, on the other hand, the tips may be formed with the conditions that each dot has a size of about 10 μm to 40 μm and a height of about 10 μm to 40 μm, and the dot type tips are spaced apart from each other by 50 μm to 100 μm.

Also, a pair of tips may be formed in each discharge cell. Preferably, the tips are formed using an inkjet method or a screen printing method. The pair of tips may be disposed at positions corresponding to the inner ends of the opposite transparent electrodes in a discharge cell. If the tips are formed in the dot type structure, it is convenient to arrange the dot type tips at regular intervals when forming a process for manufacturing the plasma display panel. Also, it is possible to concentrate the dot type tips in the discharge cell region in consideration of the electric field concentration effect.

Subsequently, a protective layer is formed on the upper dielectric layer and the tips. At this time, tips are also formed at the protective layer because the tips are formed on the upper dielectric layer. For instance, the protective layer as formed automatically includes tips since the layer below (upper dielectric layer) has the tips. After that, a lower panel and barrier ribs are formed, and the lower panel is joined to the upper panel while the barrier ribs are disposed between the lower panel and the upper panel. As a result, the plasma display panel is completed. Here, the process for forming the lower panel and the barrier ribs and the process for joining the lower panel to the upper panel while disposing the barrier ribs between the lower panel and the upper panel are the same as the conventional art, and thus the details thereof are not provided herein.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a first panel and a second panel coupled to the first panel with a distance therebetween,
wherein the first panel comprises at least one pair of tips formed at a dielectric layer disposed on the first panel at a surface thereof contacting a discharge space.

2. The plasma display panel according to claim 1, wherein the at least one pair of tips are formed in a discharge cell such that the tips are opposite to each other about a discharge gap defined between the tips.

3. The plasma display panel according to claim 1, wherein the at least one pair of tips are formed in a discharge cell such that the tips are disposed at positions corresponding to inner ends of opposite transparent electrodes.

4. The plasma display panel according to claim 1, wherein the at least one pair of tips are constructed in a line type structure.

5. The plasma display panel according to claim 4, wherein each line type tip in the at least one pair of line type tips has a width of approximately 10 μm to 40 μm.

6. The plasma display panel according to claim 4, wherein each line type tip in the at least one pair of line type tips has a height of approximately 10 μm to 40 μm.

7. The plasma display panel according to claim 1, wherein the at least one pair of tips are constructed in a dot type structure.

8. The plasma display panel according to claim 7, wherein each dot type tip of the at least one pair of dot type tips includes a plurality of dots extending in a line.

9. The plasma display panel according to claim 8, wherein the dots of the at least one pair of dot type tips are concentrated in a discharge cell region.

10. The plasma display panel according to claim 8, wherein the dots of the at least one pair of dot type tips have a size of approximately 10 μm to 40 μm.

11. The plasma display panel according to claim 8, wherein the dots of the at least one pair of dot type tips have a height of approximately 10 μm to 40 μm.

12. The plasma display panel according to claim 1, wherein the at least one pair of tips are spaced apart from each other by approximately 50 μm to 100 μm.

13. A method of manufacturing a plasma display panel, comprising:
forming a dielectric layer on a sustain electrode pair of a first panel;
forming at least one pair of tips on the dielectric layer; and
forming a protective layer on the dielectric layer having the at least one pair of tips formed thereon.

14. The method according to claim 13, wherein the step of forming the dielectric layer is carried out using a screen printing method, a green sheet lamination method, a coating method, or a dispensing method.

15. The method according to claim 13, wherein the step of forming the at least one pair of tips is carried out using an inkjet method or a screen printing method.

16. The method according to claim 13, wherein the at least one pair of tips are formed in a discharge cell such that the tips are disposed at positions corresponding to inner ends of opposite transparent electrodes.

17. The method according to claim 13, wherein the at least one pair of tips are formed in a line type structure.

18. The method according to claim 13, wherein the at least one pair of tips are formed in a dot type structure.

19. The method according to claim 18, wherein the at least one pair of dot type tips are formed in a structure in which pluralities of dots are opposite to each other in pairs.

20. The method according to claim 19, wherein the dots of the at least one pair of dot type tips are concentrated in a discharge cell region.

21. An upper panel structure for a plasma display panel, comprising:
a substrate;
a plurality of sustain electrode pairs formed on the substrate; and
a dielectric layer over the plurality of sustain electrode pairs, the dielectric layer including at least one projection corresponding to at least one of the plurality of sustain electrode pairs.

22. The upper panel structure according to claim 21, wherein the at least one projection includes a pair of projections substantially aligned with ends of one of the sustain electrode pairs.

23. The upper panel structure according to claim 22, wherein the one sustain electrode pair includes a pair of bus electrodes spaced apart from each other and formed on the substrate, and a pair of transparent electrodes formed on the pair of bus electrodes, and
the pair of projections are aligned with inner ends of the pair of bus electrodes.

24. The upper panel structure according to claim 21, further comprising:
a protective layer over the dielectric layer having the at least one projection.

25. The upper panel structure according to claim 21, wherein the at least one projection has a line type structure or a dot type structure.

26. A plasma display panel device comprising:
a first panel including a plurality of address electrodes;
a second panel including a pair of sustain electrodes, and a dielectric layer having at least one projection corresponding to the pair of sustain electrodes; and
barrier ribs disposed between the first and second panels.

27. The plasma display panel device according to claim 26, wherein the at least one projection includes a pair of tips substantially aligned with inner end parts of the pair of sustain electrodes.

28. The plasma display panel device according to claim 26, wherein the at least one projection extends along with the pair of sustain electrodes in the same direction.
